(19) United States
(12) Patent Application Publication
(10) Pub. No.: US 2011/0232066 A1
(43) Pub. Date: Sep. 29, 2011

(54) Device and Method for Anchoring a Beam or a Bar Against an Element

(75) Inventor: Sven Olerud, Lanna (SE)

(73) Assignee: SPHEROFIX AB, Lanna (SE)

(21) Appl. No.: 13/123,700

(22) PCT Filed: Oct. 9, 2008
(86) PCT No.: PCT/SE2008/000548

§ 371 Date: May 17, 2011

(30) Foreign Application Priority Data
Oct. 9, 2008 (SE) PCT/SE08/000548

(51) Int. Cl. B23P 11/00; B23P 19/00

(52) U.S. Cl. 29/428; 29/700

(57) ABSTRACT

The invention concerns an arrangement for anchoring a beam or a bar against an element for example a camera tripod and solves the problem of securing said beam or bar using only one hand. The mechanism comprises a screw-fit connection in the form of a locking or holder sleeve which locates a shaft or round tube and which has a locking ring at one end, the other end being externally threaded, cone-shaped and slit. This thread cooperates with an internal thread in a spherical, slit ring sleeve mounted inside a spherical cavity in one end of the object to which the shaft or tube is being secured. The other end of the object includes a means for securing it to a tripod or similar stand. The shaft or tube can be moved or adjusted in any direction and at any angle inside the sleeve, so long as the sleeve and its cone-shaped part are not screwed into the ring sleeve.

### TECHNICAL FIELD OF THE INVENTION

The present invention relates to a device for with a single operation fastening and fixing a handle or round tube to an element so that they can take up any arbitrarily selected angle with each other in any arbitrarily selected plane of their respective rotational positions, e.g. a camera with a shaft in the form of a tube for fastening to a tripod, wherein the device comprises a screw joint in the form of a shaft-receiving, rotatable tubular retaining sleeve with a projecting tubular part which at its outer end is conical, slotted and provided with an external thread, preferably a helical thread, which is complementary with an internal helical thread in a spherical, slotted bushing which is situated in a spherical cavity situated in one end of the element, wherein the other end of the element is provided with means for fastening to a tripod attachment or the like, wherein the shaft is freely slidable as long as the sleeve and its conical part are not screwed down into the sphere's conical thread in the spherical cavity in the element.

### TECHNICAL BACKGROUND OF THE INVENTION

There are many different solutions for fastening several elements to each other at different angles and in different planes.

It is however difficult with these prior art solutions to easily fix and fasten e.g. a camera to a tripod at varying heights and angles, especially with just one hand.

These prior art solution have certain limitations with regard to all of today's requirements for ease of use, precision, continuous flexibility with regard to angular positions and security when fastening e.g. a camera in different angles and heights.

### SHORT DESCRIPTION OF THE INVENTIVE CONCEPT

The object of the present invention is to overcome the above-mentioned problems and disadvantages when connecting and fixing rod-shaped elements to each other.

In accordance with the concept of the invention the above-mentioned problem is solved by said device having a stand attachment with one end provided with a spherical cavity in which a deformable elastic bushing in the form of annular bushing is arranged. The annular bushing is divided into segments, flanges and has a spherical shape which is complementary to the spherical shape of the cavity and wherein the annular bushing has a conical threaded inner shape which is complementary to an external thread on a conical slotted part with a conical thread, situated at the lower end of a tubular locking- and retaining-sleeve which surrounds a rod or a handle which is mounted on e.g. a camera and during screwing of the conical slotted screw into the spherical annular bushing the camera with the rod is firmly gripped and thereby is locked in any desired angle, height and any desired plane.

Thus the invention comprises three main elements which when joined together form a stable combination which comprises, a stand attachment with a hole in one end for a bolt in a stand, and with a through spherical hole in the other end, which can be angled at 45° in order to maximise angular variations, and a complementary spherical annular bushing able to be positioned in this spherical hole and, able to be introduced into this, a conical threaded part, screw, of a holder sleeve able to receive the rod which at its other end is provided with a knurled ring. The spherical bushing, the mantel surface of which is divided into flanges held together by an annular part at the end of the annular bushing is placed in the spherical hole. The flanges are elastically bendable towards the centre of the bushing, which makes it easy to press it into the spherical cavity of the plate, where it thereafter stays in place by itself. The flanges of the bushing delimit an internal conical cavity and each flange is provided on the inside with a part of a conical thread. Together, these threaded parts form a conical internal thread. The screw, the retaining part's lower part, is conical with external conical threads which during the final stage of being tightening grip the internal conical thread of the bushing, the flanges. Before that the locking- and retaining-sleeve and connected rod may be positioned at any angle and rotational position in order to optimally drive the screw further until the threaded cone of the screw in the head grips the thread of the flanges of the bushing.

The pressure that is exerted against the screw makes it push the bushing down into the lower part of the hole where it is wedged tight and thereby removes the possibility that the spherical bushing rotates while the screw is being driven to a stop when the flanges of the bushing are pressed tight in the spherical hole.

A pin is arranged in the stand attachment in order to lock the position of the annular, slotted bushing and to prevent it from rotating.

### BRIEF DESCRIPTION OF ENCLOSED FIGURES

FIG. 1 shows a view from the side of a device according to the present invention applied to a camera tripod.

FIG. 2 shows the constituent parts of the device viewed in partly disassembled state, viewed from the side.

FIG. 3 shows the invention applied on a stand attachment in perspective view, viewed obliquely from below.

FIG. 4 shows, viewed in perspective view from the side, a spherical, deformable and slotted bushing, a stand attachment with a spherical cavity, a locking- and retaining-sleeve with a conical, slotted lower part and a knurled ring in the upper end, which constitute a device according to the present invention.

### DETAILED DESCRIPTION OF A PREFERRED EMBODIMENT OF THE INVENTION

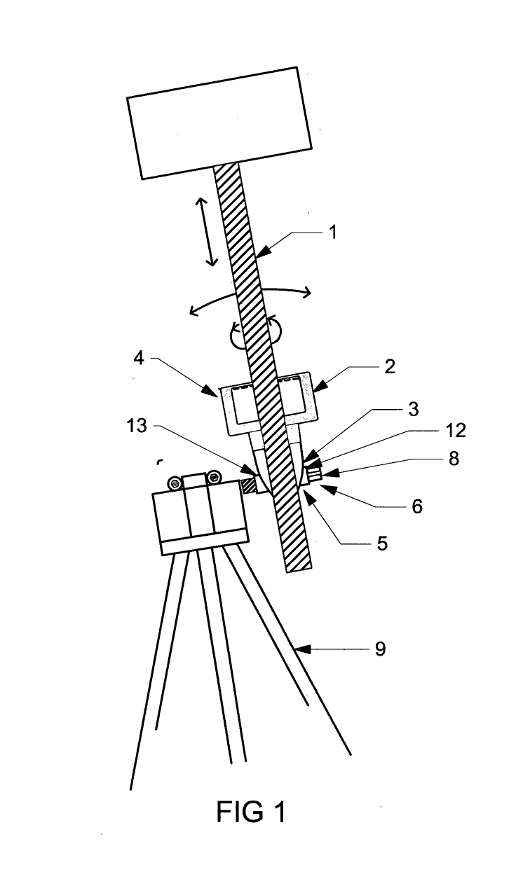

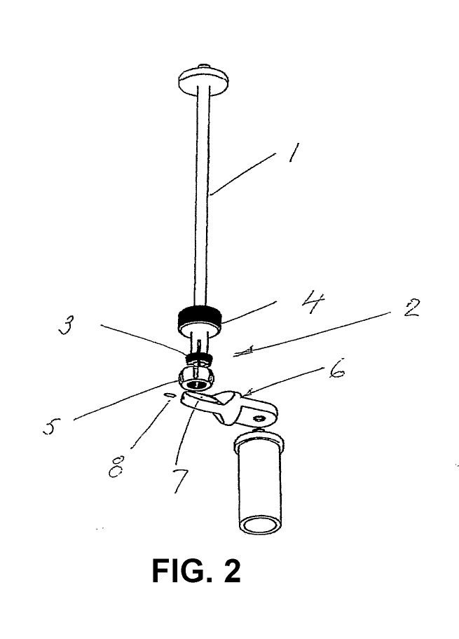

FIGS. 1 and 2 show a stand attachment 6, of a hard workable material, preferably metal, comprised in the device according to the present invention. The stand attachment may vary in thickness. In one end the stand attachment 6 has a spherical through hole 7.

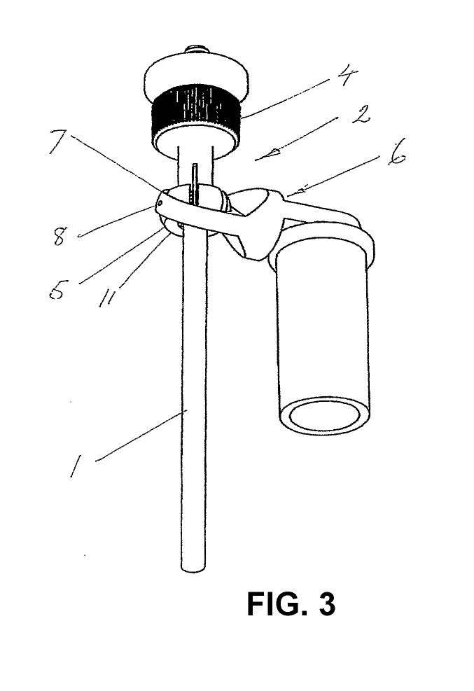

FIG. 3 shows the annular bushing 5, stand attachment 6 and the conical threaded part 3, the screw, in the screwed-in position with the screw and the bushing viewed in perspective obliquely from below. The conical threaded part 3, the screw, is completely screwed into the annular bushing 5 and the flanges 12 of the annular bushing 5 fill up the spherical hole 7. The annular bushing 5 is locked against rotation by a pin 8 arranged on the inside of the spherical hole so that the annular bushing 5 does not rotate with the conical part 3, the screw, during tightening.

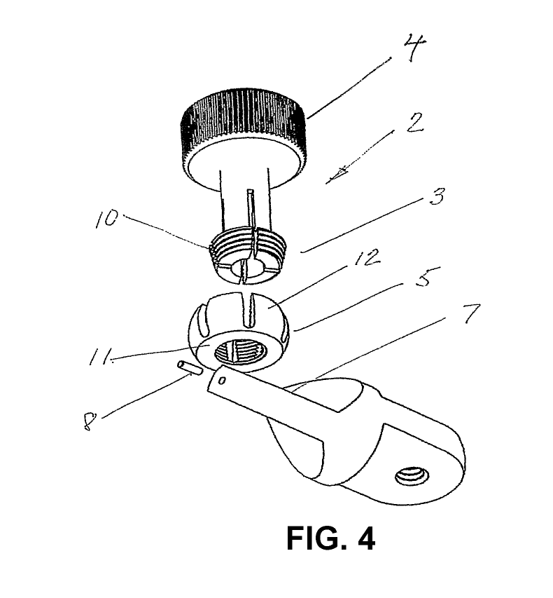

FIG. 4 shows a spherical annular bushing 5, of a suitable material preferably also a metal, with a spherical shape with slits which delimit flanges and which leave a thin connection 11 left between the so-produced flanges. This connection, in the shape of a ring 11 allows, without being deformed, the flanges 12 to be elastically bent inwards so that the annular bushing 5 may be squeezed into the spherical hole 7 of the hold 6. The annular bushing 5 is kept in position in the spherical hole 7 when the flanges 12 regain their normal shape. The spherical shape of the bushing 3 facilitates unlimited tilted positions for it. The interior of the annular bushing 5 is mainly cone-shaped but becomes cylindrical in its lower part with dimensions adapted to the conical threaded part, screw, so that the annular bushing 5 is kept in place in the attachment 6 with the annular part 11 in the lower part of the hole 7. The inside of the conical part of the annular bushing 5 is provided with a thread 10 and the flanges 12 have sharp edges in order to increase the retaining effect.

During tightening of the knurled ring 4 of the locking- and retaining-sleeve the threads of the head of the screw start to engage in the thread of the annular bushing, at the same time as the slotted bushing expands and locks the bushing against the spherical surface of the hole 7 on the under side of the attachment 6, presses outwardly towards the edges of the sphere 7 and locks the annular bushing rotationally during rotation of the conical shape 3 of the locking- and retaining-sleeve 2 against the spiral threaded cone on the inside of the sphere, the flanges of which 12 are locked against the inside of the spherical hole 7 during rotation of the knurled ring 4.

During the screwing-in of the locking- and retaining-sleeve 2, its slotted sides are pressed against the surrounded rod, the handle 1.

When the two elements are to be joined together with a device according to the invention in order to fasten the first element, in the shape of a rod 1, with the second element 2, in the shape of a rod-receiving locking- and retaining-sleeve, by means of a conical threaded part 3 of the locking- and retaining-sleeve, the conical threaded part 3 is pushed in through the spherical hole 7 in which the flanges 11 of the annular bushing 5 are placed. The conical shaped, threaded part 3, the screw, is pushed in so far that it touches the annular bushing 5. The desired direction of the conical shaped part with the fitted pole therein, 3 is selected, and then the rotation of the knurled ring is continued. The final rotation occurs when the thread of the conical, threaded part 3 totally fills up the conical thread in the annular bushing 5 and thereby presses the annular bushing 5 and its flanges 11 in the spherical hole 7 and finally the annular part 11 of the bushing 5 is pressed out of the lower opening of the hole 7.

During the screwing-in of the locking- and retaining-sleeve its slotted sides are pressed against the surrounded rod, the handle, in the cone and lock it. Simultaneously, the conical shape of the annular bushing is pressed against the spiral threaded cone of the inside of the sphere, the flanges of which then presses the flanges of the sphere against the spherical interior of the hole in the stand attachment.

The object of the invention is to simplify the locking mechanism of a rod shaped element to an attachment, where locking in all planes is executed with a single action. As long as the locking moment has not been triggered, the rod and its end attachment can move in the longitudinal direction at the same time as it may rotate completely freely.

During rotation of the locking- and retaining-sleeve its flanges will close in the hole of the bushing and grip the rod and lock it. The rotational movement of the sleeve in the conical threaded cavity of the sphere squeezes apart the flanges of the sphere which press against the spherical shape of the interior of the hole on the attachment that is mounted on a stand or the like. In this way locking of the position of the sphere, the rotation of which is prevented by the pin 8 mounted on the inside of the spherical hole, may be accomplished. Since the attachment is provided with a 45 degree angle and this can be given different adjustments the rod may take any desired angle out of the totality of 360 degrees.

The present invention may of course be modified within the frame of the enclosed claims without changing the scope of the protection.

1-5. (canceled)

6. A device for fastening and fixing a first element to a second element at a selected angle with respect to each other and in a selected plane comprising: an externally threaded first sleeve adapted to engage an internally threaded second sleeve, the first and second sleeves being slotted to form segments, the segments of the second sleeve defining are generally spherical in shape, attachment arm adapted to be connected to a stable support, the attachment arm having a opening with an internal surface defining a generally spherical cavity shaped to receive the external and generally spherical external surfaces of the segments of the second sleeve.

7. A device according to claim 6, wherein the second sleeve comprises a bushing with the segments of the second sleeve connected by an uninterrupted annular ring.

8. A device according to claim 7, where external threads on the first sleeve are tapered, and the second sleeve fits into the second sleeve whereby rotation of the first sleeve within the second sleeve causes expansion of the segments of the second sleeve into engagement of the generally spherical surfaces of the opening in the attachment arm, and the second sleeve is fully anchored in the spherical cavity.

9. A device according to claim 8, wherein the device includes a pin extending inwardly from the spherical cavity to a location between segments of the second sleeve, whereby the pin restricts rotation of the second sleeve as the first sleeve is rotated within the second sleeve.

10. Method for fastening and fixing a first sleeve to a second sleeve with a device according to claim 1, comprising inserting first sleeve into the second sleeve, rotating the first sleeve relative to the second sleeve, such that external threads on the first sleeve engage internal threads on the second sleeve, causing the segments of the second sleeve to spread in the direction of the spherical cavity of the attachment arm, and prior to finally tightening the first sleeve in the second sleeve, adjusting the angular position of the first sleeve relative to the attachment arm, and finally tightening the first sleeve in the second sleeve in order to tightly lock the two sleeves to each other.
